(19) United States
(12) Patent Application Publication
(10) Pub. No.: US 2026/0322512 A1
(43) Pub. Date: Oct. 15, 2026

(54) QoS splitting in U2U Relay

(71) Applicant: InterDigital Patent Holdings, Inc., Wilmington, DE (US)

(72) Inventors: Tuong Duc Hoang, Montreal (CA); Martino M. Freda, Laval (CA); Oumer Teyeb, Montreal (CA); Ananth Kini, Conshohocken, PA (US)

(73) Assignee: InterDigital Patent Holdings, Inc., Wilmington, DE (US)

(21) Appl. No.: 19/116,636

(22) PCT Filed: Sep. 28, 2023
(86) PCT No.: PCT/US2023/034016

§ 371 Date: Mar. 28, 2025

Related U.S. Application Data
(60) Provisional application No. 63/410,820, filed on Sep. 28, 2022.

(51) Int. Cl. H04B 17/318; H04W 56/00

(52) U.S. Cl. CPC H04B 17/328; H04W 56/0045

(57) ABSTRACT

System, methods, and instrumentalities may be configured for QoS splitting in a relay wireless transmit receive unit (WTRU). A first WTRU (e.g., a relay WTRU) may receive configuration information that indicates Packet Delay Budget (PDB) split information. The first WTRU may receive from a second WTRU (e.g., a source WTRU) a second WTRU channel busy ratio (CBR) and an End-to End (E2E) PDB associated with a Quality of Service (QoS) flow. The first WTRU may determine a first WTRU CBR and a first WTRU load. The first WTRU may determine a PDB split. The PDB split may be based on the PDB split information, the second WTRU CBR, the first WTRU CBR, and the first WTRU load. The first WTRU may send to the second WTRU an indication. The indication may indicate a PDB for a transmission from the second WTRU to the first WTRU.

### CROSS-REFERENCE TO RELATED APPLICATIONS

This application claims the benefit of Provisional U.S. Patent Application No. 63/410,820, filed Sep. 28, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

System, methods, and instrumentalities are provided for QoS splitting that may be associated with a relay wireless transmit receive unit (WTRU). A first WTRU (e.g., a relay WTRU) may receive configuration information that indicates Packet Delay Budget (PDB) split information. The first WTRU may receive from a second WTRU (e.g., a source WTRU) a second WTRU channel busy ratio (CBR) and an End-to End (E2E) PDB associated with a Quality of Service (QoS) flow. The first WTRU may determine a first WTRU CBR and a first WTRU load. The first WTRU may determine a PDB split. The PDB split may be based on the PDB split information, the second WTRU CBR, the first WTRU CBR, and the first WTRU load. The first WTRU may send to the second WTRU an indication. The indication may indicate a PDB for a transmission from the second WTRU to the first WTRU (e.g., in accordance with the determined PDB split).

The first WTRU may perform resource selection for a transport block (TB) based on the determined PDB split. The PDB split information may include PDB split ranges and a PDB split value. The first WTRU may determine the PDB split ranges based on the second WTRU CBR and the first WTRU CBR. The first WTRU may determine the PDB split value based on the first WTRU load.

The first WTRU load may be determined based on a channel occupancy ratio and/or a number of links associated with the first WTRU. The first WTRU may determine a PDB split value based on the E2E PDB and the PDB split information. The PDB split value may include a first hop PDB value associated with a first hop and/or a second hop PDB value associated with a second hop.

The PDB split information may include a PDB split calculation as a function of the first WTRU CBR, the second WTRU CBR, and the first WTRU load. When determining that the PDB split, the first WTRU may determine the PDB split based further on the PDB split calculation. The first WTRU CBR may be based on a resource pool.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example user plane protocol stack for an L2 WTRU-to-network relay.

FIG. 3 illustrates an example control plane protocol stack for an L2 WTRU-to-network relay.

FIG. 4 illustrates an example of a U2N relay.

FIG. 5 illustrates an example of U2U relays.

FIG. 6 illustrates an example of PDB splitting.

### DETAILED DESCRIPTION

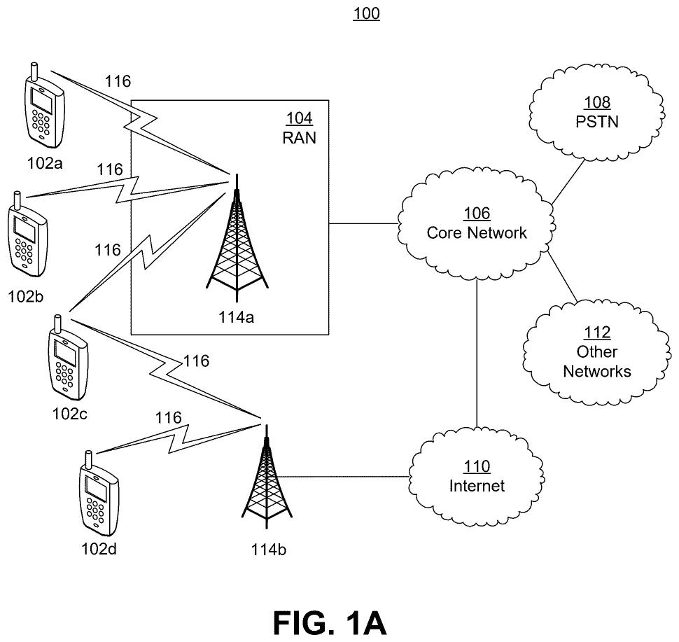

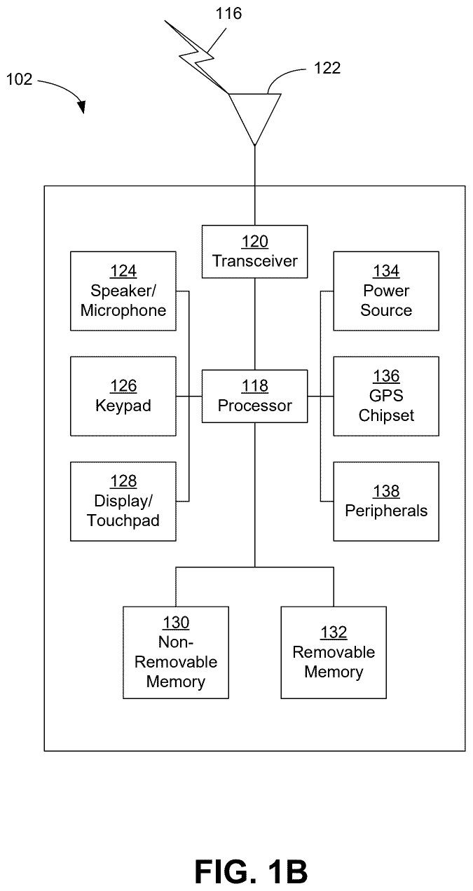

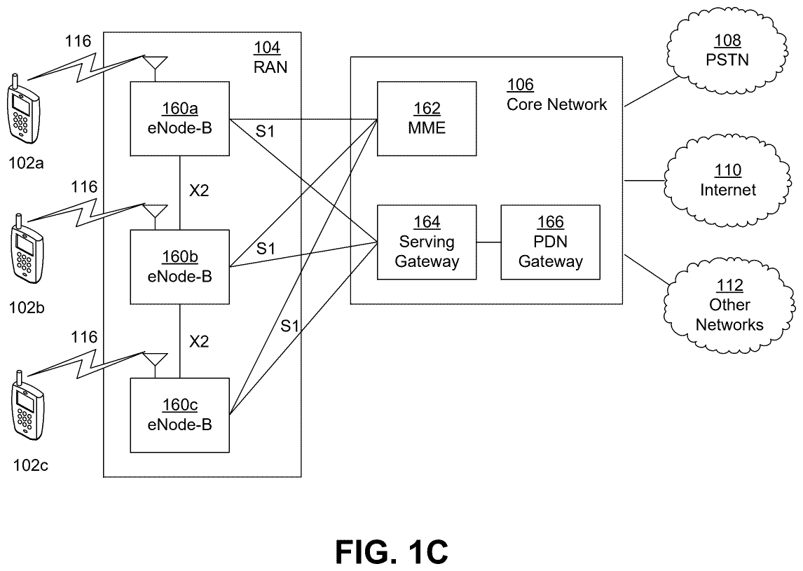

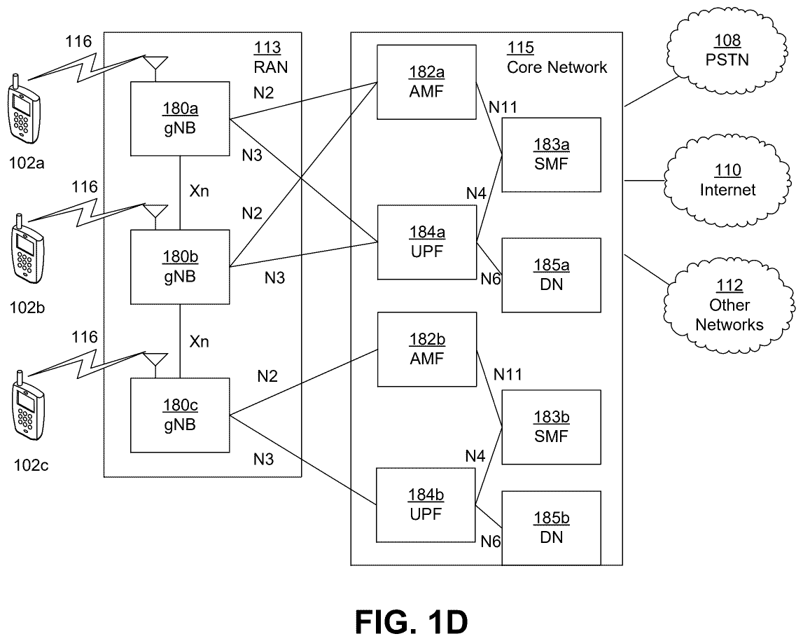

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. In examples, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. In examples, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. In examples, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. In examples, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. In examples, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. In examples, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. In examples, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). In examples, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. In examples, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. In examples, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. In examples, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. In examples, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. In examples, the CN 106 may provide the WTRUs 102a, 102b, 102c with access to circuit-switched networks, such as the PSTN 108, to facilitate communications between the WTRUs 102a, 102b, 102c and traditional land-line communications devices. In examples, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. In examples, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. In examples, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. In examples, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. In examples, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. In examples, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. In examples, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. In examples, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. In examples, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. In examples, the emulation devices may be used to test other devices and/or to simulate network and/or WTRU functions.

The emulation devices may be designed to implement one or more tests of other devices in a lab environment and/or in an operator network environment. In examples, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. In examples, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Packet delay budget (PDB) splitting for one or more WTRUs (e.g., both WTRUs) being out of coverage or in coverage may be provided. A WTRU (e.g., a relay WTRU) may determine the PDB splitting ratio between two hops based on the reported CBR from the source WTRU, its measured channel busy ratio (CBR), and/or its load. The WTRU (e.g., WTRU-to-WTRU (U2U) relay) may perform one or more of the following PDB splitting between the source-relay and relay-destination hop. The WTRU may be (pre-) configured with one or more of the following parameters: PDB splitting ratio as a function of its measured and reported CBRs and/or its load. The WTRU may receive the E2E PDB and CBR measurement for a sidelink radio bearer/(SLRB/LCH) from the source WTRU. The WTRU may measure the CBR of the resource pool. The WTRU may determine its load (e.g., based on a channel occupancy ratio (CR)). The WTRU may determine the PDB splitting ratio based on the at least two CBRs and/or its load. In examples, the WTRU may determine the PDB splitting ranges based on a CBR and may determine the PDB split value (e.g., a first hop PDB value and/or a second hop PDB value) based on its load (e.g., a load of the WTRU). The PDB split value may be based on the E2E PDB and the PDB split information. The WTRU may indicate the PDB splitting to the other WTRU (e.g., source WTRU). The WTRU may perform resource selection and transmission for a transport block (TB) from the source WTRU based on the determined PDB splitting of a QoS flow associated with the TB.

A PDB may be split when the source is in mode 1 and the U2U relay is in mode 2. A WTRU (e.g., source WTRU) may calculate/determine the PDB of the first hop (e.g., source-U2U relay hop) and may trigger reporting the PDB to the gNB based on a reception of the PDB in the second hop from the U2U relay. The WTRU (e.g., source WTRU) may perform one or more of the following for QoS splitting between the source-relay and relay-destination hop. The WTRU may receive the PDB configuration (e.g., from the U2U relay) which may indicate the PDB for an SLRB/LCH of the second hop (e.g., U2U relay-destination). The WTRU may determine the PDB associated with the first hop based on the indicated PDB in the second hop and E2E PDB of the SLRB/LCH. The WTRU may trigger/report the PDB in the first hop to the gNB.

A HARQ may be enabled/disabled. A WTRU (e.g., source WTRU) may determine whether to enable/disable HARQ feedback for a transport block (TB) based on the HARQ enabling/disabling of the associated SLRB/LCH in the second hop indicated from the U2U relay and CBR of the resource pool. The WTRU (e.g., U2U relay) may perform one or more of the following to determine whether to enable/disable HARQ for a TB (e.g., one TB) or SLRB/LCH. The WTRU may be (pre-)configured with a CBR threshold to enable HARQ feedback for a HARQ feedback SLRB/LCH. The WTRU may receive data from the first hop indicating whether HARQ is enabled/disabled. The WTRU may determine whether to enable/disable HARQ for a TB (e.g., one TB) based on whether HARQ is enabled/disabled in the first hop and CBR of the resource pool. In examples, if HARQ is enabled for the first hop, a WTRU may determine to enable HARQ for the second hop. If HARQ is disabled for the first hop, the WTRU may determine to enable HARQ for the second hop if the CBR is greater than a threshold. The WTRU may disable HARQ feedback.

SL-based WTRU (e.g., WTRU) to network relays may be provided. Sidelink relay may support a ProSe (e.g., 5G ProSe) WTRU-to-network relay (U2N Relay, such as WTRU-to-network relay) function to provide connectivity to the network for U2N remote WTRU(s). L2 and L3 U2N relay architectures may be supported. The L3 U2N relay architecture may be transparent to the serving RAN of the U2N Relay WTRU.

A U2N relay WTRU may be in RRC_CONNECTED to perform relaying of unicast data. For an L2 U2N relay operation, one or more of the following RRC state combinations may be supported: a U2N relay WTRU and U2N remote WTRU may be in RRC CONNECTED to perform transmission/reception of relayed unicast data; the U2N relay WTRU may be in RRC_IDLE, RRC_INACTIVE, or RRC_CONNECTED as long as the U2N remote WTRU(s) (e.g., all the U2N remote WTRUs) that are connected to the U2N Relay WTRU are in RRC_INACTIVE or in RRC_IDLE.

For L2 U2N relay, the U2N remote WTRU may be configured to use resource allocation mode 2 for data to be relayed. A single unicast link may be established between an L2 U2N relay WTRU (e.g., one L2 U2N relay WTRU) and an L2 U2N remote WTRU (e.g., one L2 U2N remote WTRU). The traffic of U2N remote WTRU via a given U2N relay WTRU and the traffic of the U2N relay WTRU may be separated in Uu RLC channels over Uu.

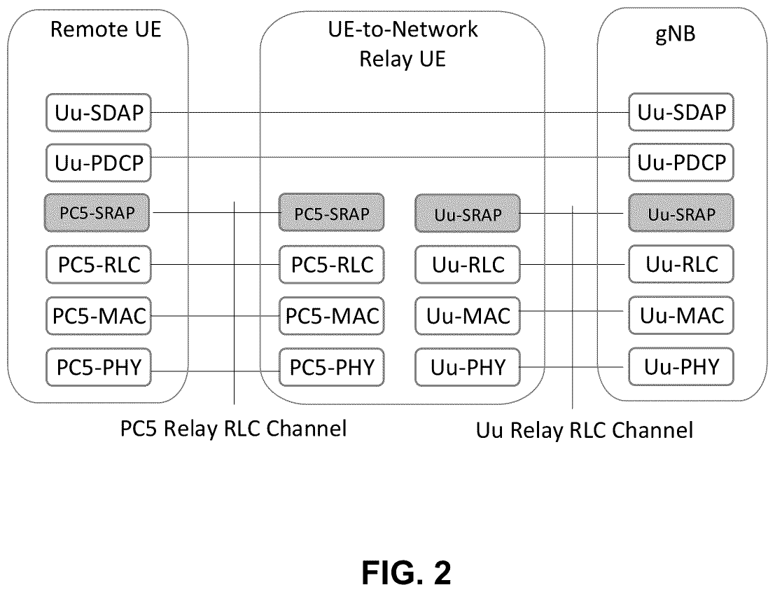

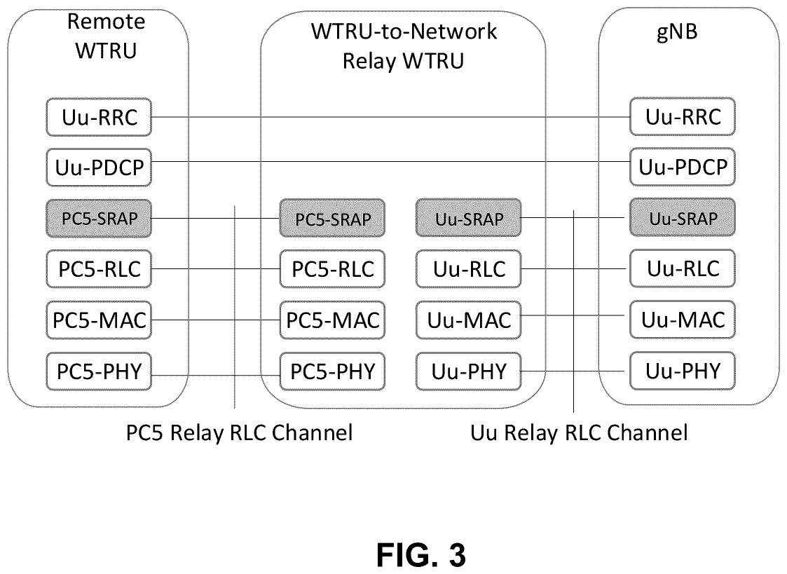

FIG. 2 shows an example user plane protocol stack for an L2 WTRU-to-network relay. FIG. 3 shows an example control plane protocol stack for an L2 WTRU-to-network relay. An L2 U2N relay protocol architecture may be provided. The protocol stacks for the user plane and control plane of the L2 U2N Relay architecture may be provided, as shown in FIGS. 2 and 3. The Sidelink Relay Adaptation Protocol (SRAP) sublayer may be placed above the RLC sublayer for both control plane (CP) and user plane (UP) at the PC5 interface and the Uu interface. The Uu Service Data Adaptation Protocol (SDAP), Packet Data Convergence Protocol (PDCP), and RRC may be terminated between the L2 U2N remote WTRU and the gNB. SRAP, RLC, MAC and PHY may be terminated in a hop (e.g., a hop such as the link between L2 U2N remote WTRU and L2 U2N relay WTRU and the link between L2 U2N relay WTRU and the gNB). For the L2 U2N relay, the SRAP sublayer over PC5 hop may be for bearer mapping. The SRAP sublayer may not be present over a PC5 hop for relaying the L2 U2N remote WTRU's message on a Broadcast Control Channel (BCCH) and physical control channel (PCCH). For L2 U2N remote WTRU's message on SRB0, the SRAP sublayer may not be present over PC5 hop. The SRAP sublayer may be present over Uu hop for DL and UL.

Based on the L2 U2N relay for uplink, one or more of the following may apply. The Uu SRAP sublayer may support UL bearer mapping between ingress PC5 Relay RLC channels for relaying and egress Uu relay RLC channels over the L2 U2N Relay UE Uu interface. For uplink relaying traffic, the end-to-end radio bearers RBs (e.g., SRBs or DRBs) of the same remote WTRU and/or different remote WTRUs may be multiplexed over the same Uu relay RLC channel. The Uu SRAP sublayer may support L2 U2N remote WTRU identification for the UL traffic. The identity information of the L2 U2N remote WTRU Uu radio bearer and a local remote WTRU ID may be included in the Uu SRAP header at UL for gNB to correlate the received packets for the PDCP entity associated with the right Uu radio bearer of a remote WTRU. The PC5 SRAP sublayer at the L2 U2N remote WTRU may support UL bearer mapping between remote WTRU Uu Radio Bearers and egress PC5 relay RLC channels.

Based on the L2 U2N Relay for downlink, one or more of the following may apply. The Uu SRAP sublayer may support a DL bearer mapping at gNB to map end-to-end radio bearer (e.g., SRB and/or DRB) of a remote WTRU into a Uu relay RLC channel over a relay WTRU Uu interface. The Uu SRAP sublayer may support DL bearer mapping and data multiplexing between multiple end-to-end radio bearers (e.g., SRBs or DRBs) of a L2 U2N remote WTRU and/or different L2 U2N remote WTRUs and a Uu relay RLC channel (e.g., one Uu relay RLC channel) over the relay WTRU Uu interface. The Uu SRAP sublayer may support remote WTRU identification for DL traffic. The identity information of a remote WTRU Uu radio bearer and a local remote WTRU ID may be included in the Uu SRAP header by the gNB at DL for the relay WTRU to map the received packets from the remote WTRU Uu Radio Bearer to its associated PC5 relay RLC channel. The PC5 SRAP sublayer at the relay WTRU may support DL bearer mapping between ingress Uu relay RLC channels and egress PC5 relay RLC channels. The PC5 SRAP sublayer at the remote WTRU may correlate the received packets for the PDCP entity associated with the right Uu radio bearer of a remote WTRU based on the identity information included in the Uu SRAP header.

A local remote WTRU ID may be included in the PC5 SRAP header and the Uu SRAP header. The L2 U2N relay WTRU may be configured by the gNB with the local remote WTRU ID to be used in the SRAP header. The remote WTRU may obtain the local Remote ID from the gNB via Uu RRC messages including RRCSetup, RRCReconfiguration, RRCResume and/or RRCReestablishment. Uu DRB(s) and/or Uu SRB(s) may be mapped to PC5 relay RLC channels and Uu relay RLC channels in a PC5 hop and a Uu hop. The gNB's may avoid collision on the usage of a local remote WTRU ID. The gNB may update the local remote WTRU ID by sending the updated local remote ID via an RRCReconfiguration message to the relay WTRU. The serving gNB may perform a local remote WTRU ID update independent of the PC5 unicast link L2 ID update procedure.

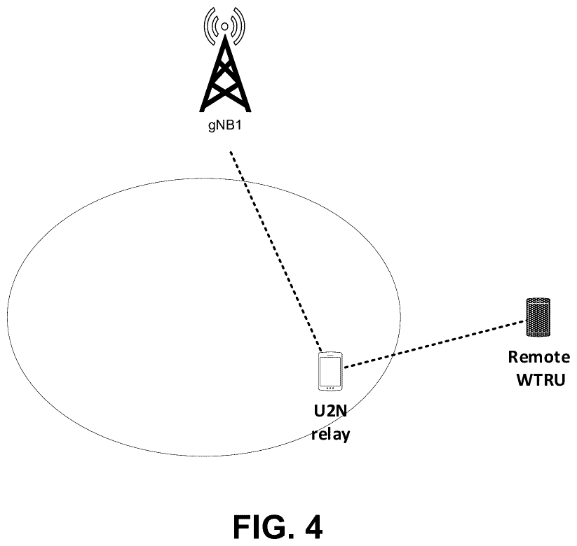

FIG. 4 shows an example U2N relay scenario. QoS splitting in a U2N relay may be provided. In a U2N relay, the gNB may be responsible for QoS Splitting (e.g., PDB splitting) between hops (e.g., two hops: gNB to U2N relay hop and U2N relay-remote WTRU hop). The gNB may configure the delay budget associated with legs (e.g., Uu and/or PC5). To help the gNB in the configuration, CBR, Uu RSRP, and SL-RSRP measurement reports from the remote and U2N relay may be supported.

In a U2U relay, QoS splitting may occur between two hops (e.g., source-U2U relay hop and U2U relay-destination hop). For the U2U relay scenario, a WTRU (e.g., each WTRU) may be in a coverage status (e.g., in coverage and/or out of coverage), using a resource allocation mode (e.g., mode 1 and/or mode 2). The WTRU may be configured with a HARQ enabled/disabled sidelink UL and SL resources. Performing QoS splitting between hops (e.g., two hops) of a U2U relay considering scenarios (e.g., different coverage status, resource allocation mode, and/or HARQ resource) may be described herein.

QoS splitting configuration and QoS splitting value may be used interchangeably herein. The terms may be used to refer to the value, range of values of one or more QoS parameters for one or more hops (e.g., the source-relay hop and/or the relay-destination hop) for one or more TBs, SLRBs/LCHs, and/or ratio or range of ratios of one or more QoS parameters between a hop in a U2U scenario for one or more TBs and/or SLRBs/LCHs.

WTRU autonomous QoS splitting may be provided. The WTRU may indicate its status to another WTRU. In examples, a WTRU may indicate one or more of the following information regarding its status: coverage status; RRC status; or resource allocation mode (e.g., mode 1 vs. mode 2) for sidelink communication in U2U relay scenario. Such information may be indicated to other WTRU(s) in the discovery message, link establishment message, PC5 RRC connection, and/or after the PC5 RRC is established.

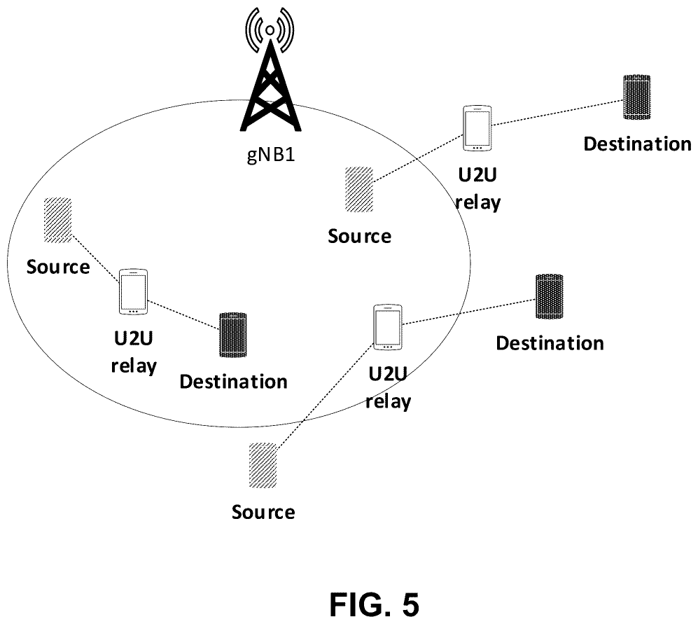

As shown in FIG. 5, the U2U relay scenario may include multiple coverage examples. A WTRU (e.g., source WTRU, U2U relay, and destination WTRU) may be in coverage and out of coverage. The WTRU may be in coverage of the same gNB or in coverage of different gNBs. FIG. 5 shows an example of U2U relay scenarios.

The WTRU may perform the QoS splitting procedure. In examples, a WTRU (e.g., relay WTRU) may perform QoS splitting between the first hop and the second hop for E2E QoS of one or more TBs and/or SLRB/LCH in a U2U relay scenario. A QoS splitting procedure may include one or more of the following. The QoS splitting procedure may include determining the value or range of values of one or more QoS parameters for one or more hops (e.g., the source-relay hop and/or the relay-destination hop) for one or more TBs and/or SLRBs/LCHs. In examples, for a (e.g., one) E2E PDB of a TB and SLRB/LCH, the WTRU may determine the first hop delay budget and second hop delay budget. The WTRU may determine the first hop delay budget and second hop delay budget such that the total delay of two hops is within the E2E PDB associated with the TB or SLRB/LCH. In examples, for a (e.g., one) packet error rate (PER) associated with a TB and SLRB/LCH, the WTRU may determine the first hop PER and the second PER. The WTRU may determine the first hop PER and the second hop PER such that the total PER of two hops is within the E2E PER.

A QoS splitting procedure may include determining the ratio or range of ratios of one or more QoS parameters between two hops. In examples, for one E2E PDB of a TB and SLRB/LCH, the WTRU may determine the ratio first hop delay budget and second hop delay budget. The WTRU may determine the first hop delay budget (e.g., a first hop PDB) and second hop delay budget (e.g., second PDB) such that the total delay of two hops is within the E2E PDB associated with the TB and SLRB/LCH. In examples, for one PER associated with a TB and SLRB/LCH, the WTRU may determine the first hop PER and the second PER. The WTRU may determine the first hop PER and the second hop PER such that the total PER of two hops is within the E2E PER.

A QoS splitting procedure may include indicating the information about the QoS splitting between two hops to another node (e.g., gNB, U2U relay, source WTRU, and/or destination WTRU). In examples, the U2U relay may determine the PDB splitting between two hops. The U2U relay may indicate the PDB splitting configuration to the source WTRU (e.g., using PC5 RRC). The U2U relay may indicate the PDB splitting configuration to gNB if it is connected to a gNB (e.g., using RRC message). In examples, the source WTRU may determine the PDB splitting between two hops. The WTRU may indicate the PDB splitting configuration to the U2U relay (e.g., using PC5 RRC). The source WTRU may indicate the PDB splitting configuration to the gNB if it is connected to a gNB (e.g., using an RRC message).

The WTRU may determine the QoS splitting value. QoS splitting value may be used to indicate the value, range of values of one or more QoS parameters (e.g., PDB and/or PER) of one or more hops (e.g., the source-U2U relay and U2U relay-destination hops), and/or the ratio, range of ratios of one or more QoS parameters between two hops. In examples, a QoS splitting value may be used to describe the PDB splitting ratio or the ranges of PDB splitting ratio between two hops. In examples, QoS splitting value may be used to describe PER splitting in a hop (e.g., each hop) of the E2E PER. A WTRU (e.g., U2U relay and/or source WTRU) may determine QoS splitting value based on one or more of the following. The QoS splitting value may be based on the CBR of the resource pool measured by a Tx WTRU in a hop (e.g., the source WTRU in the first hop, the U2U relay WTRU in the second hop). In examples, the U2U relay may determine the delay budget ratio and/or the per hop delay budget of a TB and SLRB/LCH based on its measured CBR and the reported CBR from the source WTRU. In examples, the source WTRU may determine the delay budget ratio and/or the per hop delay budget of a TB and SLRB/LCH based on its measured CBR and the reported CBR from the U2U relay. In examples, the U2U relay may determine the delay budget associated with the second hop (e.g., U2U relay-destination hop) based on its measured CBR of the resource pool. In examples, the source WTRU may determine the delay budget associated with the first hop (e.g., source WTRU-U2U relay hop, which may be referred to as a UE-U2U relay hop) based on its measured CBR of the resource pool.

A QoS may determine the QoS splitting value based on a link quality associated with a hop, which may be determined based on the SL-RSRP and/or channel quality indicator (CQI) associated with the hop. In examples, the U2U relay may determine the delay budget ratio and/or the per hop delay budget of a TB and SLRB/LCH based on its measured SL-RSRP and the reported SL-RSRP from the destination WTRU. In examples, the source WTRU may receive SL-RSRP measurement reporting for the first hop and the second hop from the U2U relay and the destination, respectively. The WTRU may determine the delay budget ratio and/or the per hop delay budget of a TB and SLRB/LCH based on the (e.g., the two) reported SL-RSRP values. In examples, the U2U relay may determine the delay budget associated with the second hop (e.g., U2U relay-destination hop) based on its measured SL-RSRP of the resource pool. In examples, the source WTRU may determine the delay budget associated with the first hop (e.g., source WTRU-U2U relay hop) based on its reported SL-RSRP from the U2U relay.

A QoS may determine the QoS splitting value based on a load of the Tx WTRU (e.g., each Tx WTRU). The load of the WTRU may be determined based on the channel occupation ratio (CR), buffer status, the number of links, and/or the number of supported source/destination WTRUs. In examples, the U2U relay may determine the delay budget associated with the second hop (e.g., U2U relay-destination hop) based on its load (e.g., a load of the U2U relay).

A QoS may determine the QoS splitting value based on the average obtained QoS (e.g., the average delay per SLRB/LCH).

In examples, the U2U relay may determine the range of PDB ratios between the first hop and the second hop based on its measured CBR and the CBR reported from another WTRU (e.g., source WTRU). The WTRU may determine the PDB ratio between two hops and/or the delay budget for a hop based on the load of the U2U relay. An example PDB split configuration may be shown in Table 1. The WTRU may determine the PDB split range based on the CBR of the source WTRU and the CBR of the U2U relay. The WTRU may determine the final PDB split based on the relay load.

TABLE 1
Example PDB splitting configuration and WTRU
determination of the actual PDB split

| CBR at the | CBR at | PDB split | Relay | PDB split |
|---|---|---|---|---|
| Source UE | the relay | range | load | (PDB at S-R/PDB at R-D) |
| Low | Low | [0.2, 0.8] | low | 0.5 |
| | | | High | 0.3 |
| | High | [0.2, 0.5] | Low | 0.4 |
| | | | High | 0.2 |
| High | low | [0.5, 0.8] | Low | 0.7 |
| | | | High | 0.5 |
| | High | [0.4, 0.6] | Low | 0.5 |
| | | | High | 0.4 |

The WTRU may indicate the supported QoS parameters to another WTRU. In examples, the WTRU (e.g., U2U relay) may indicate the range of one or more QoS parameters that may be supported by the WTRU. In examples, the WTRU may indicate the range of delay budget and/or PER in the second hop (e.g., U2U relay-destination hop).

The WTRU may determine whether to establish a SLRB/LCH. In examples, the WTRU may determine whether to establish a SLRB/LCH based on the QoS associated with the SLRB/LCH. The WTRU may determine the range of the E2E QoS parameters (e.g., all E2E QoS parameters) supported via the U2U relay. The WTRU may determine to establish the SLRB/LCH if the E2E QoS parameters (e.g., all E2E QoS parameters) are supported. The range of E2E QoS parameters supported may be determined based on one or more of the following: the CBR of the resource pool measured by a WTRU, the quality of a link in two hops, and/or the load of the U2U relay.

The WTRU may determine whether to accept or reject a QoS splitting configuration. A WTRU (e.g., U2U relay) may receive a QoS splitting configuration from another WTRU (e.g., a source WTRU). The WTRU may accept or reject such configuration. The WTRU may reject/accept the QoS splitting configuration based on one or more of the following: one or more QoS parameters associated with a hop of the WTRU. In examples, the WTRU may support a minimum delay budget in a hop. The WTRU may reject the QoS splitting configuration if the configured delay budget for a hop is smaller than a minimum delay budget supported by the WTRU.

The WTRU may trigger a QoS splitting procedure. In examples, a WTRU (e.g., U2U relay) may trigger a QoS splitting procedure (e.g., calculating the QoS splitting value and/or indicating the QoS splitting value to other nodes) based on one or more of the following. It may be based on the source WTRU and destination WTRU establishing an E2E connection via the U2U relay. In examples, the WTRU (e.g., U2U relay) may trigger a QoS splitting procedure based on the E2E connection establishment between the source and destination WTRUs.

The WTRU (e.g., U2U relay) may trigger a QoS splitting procedure (e.g., calculating the QoS splitting value and/or indicating the QoS splitting value to other nodes) based on the CBR of the resource pool measured by the WTRU and/or reported by another WTRU that may be smaller than a threshold or larger than a (e.g., another) threshold. In examples, the WTRU may trigger a QoS splitting procedure (e.g., to increase the delay budget of one hop) if the CBR associated with the hop becomes greater than a threshold. In examples, the WTRU may trigger a QoS splitting procedure (e.g., to increase the delay budget of one hop) if the CBR associated with the hop becomes smaller than a threshold.

A WTRU (e.g., U2U relay) may trigger a QoS splitting procedure (e.g., calculating the QoS splitting value and/or indicating the QoS splitting value to other nodes) based on the WTRU receiving the measurement report from another node triggering a QoS splitting value change. In examples, the WTRU may trigger a QoS splitting procedure (e.g., to increase the delay budget a (e.g., one) hop) if the CBR associated with the hop becomes greater than a threshold. In examples, the WTRU may trigger a QoS splitting procedure (e.g., to increase the delay budget of a (e.g., one) hop) if the CBR associated with the hop becomes smaller than a threshold.

A WTRU (e.g., U2U relay) may trigger a QoS splitting procedure (e.g., calculating the QoS splitting value and/or indicating the QoS splitting value to other nodes) based on the link quality associated with a (e.g., one) hop becoming greater/smaller than a threshold. In examples, the WTRU may trigger a QoS splitting procedure (e.g., to increase a delay budget of one hop) if the link quality of the hop is worse than a threshold. In examples, the WTRU may trigger a QoS splitting procedure (e.g., to increase a delay budget of a (e.g., one) hop) if an SL-RSRP associated with the hop becomes smaller than a threshold. In examples, the WTRU may trigger a QoS splitting procedure (e.g., to decrease the delay budget of one hop) if the SL-RSRP associated with the hop becomes larger than a threshold.

A WTRU (e.g., U2U relay) may trigger a QoS splitting procedure (e.g., calculating the QoS splitting value and/or indicating the QoS splitting value to other nodes) based on the feedback reception/transmission status. The WTRU may trigger a QoS splitting procedure (e.g., to change the PDB splitting ratio between two hops) based on the number consecutive NACK/DTX from another WTRU being greater than a threshold. In examples, a WTRU (e.g., source WTRU) may trigger a QoS splitting procedure if the number of consecutive NACK/DTX received from the U2U relay is greater than a threshold. The threshold may be (pre-)configured. The WTRU (e.g., source WTRU or U2U relay) may increase the delay budget of the first hop if the number of consecutive NACK/DTX received from the U2U relay is larger than a threshold. In examples, a WTRU (e.g., U2U relay) may trigger a QoS splitting procedure (e.g., to increase the delay budget in the second hop between U2U relay and destination WTRU) if the number of consecutive NACK/DTX received from the destination WTRU is greater than a threshold. The threshold may be (pre-)configured.

A WTRU (e.g., U2U relay) may trigger a QoS splitting procedure (e.g., calculating the QoS splitting value and/or indicating the QoS splitting value to other nodes) based on the WTRU failing to transmit one or more TBs in a window. In examples, the source WTRU or U2U relay may trigger a QoS splitting procedure (e.g., to change the PDB splitting ratio between two hops or to increase/decrease the delay budget of one or more hops) if it (e.g., the source WTRU and/or the U2U relay) fails to transmit one or more TBs within a window. For a HARQ enabled TB, the WTRU may consider transmission of a TB (e.g., one TB) as a failure if the WTRU has not received HARQ ACK feedback within the delay budget of the hop. For a HARQ disabled TB, the WTRU may consider transmission of a TB as a failure if the number of (re)transmissions for the TB is smaller than a threshold. The threshold may be (pre-)configured, which may be based on the QoS of the TB. In examples, the WTRU may increase the delay budget in the first hop if the source WTRU fails to transmit at least a (pre-)configured number of TBs in a window. In examples, the U2U relay may increase the delay budget in the second hop if it fails to transmit at least a (pre-)configured number of TBs in a window.

A WTRU (e.g., U2U relay) may trigger a QoS splitting procedure (e.g., calculating the QoS splitting value and/or indicating the QoS splitting value to other nodes) based on the average number of transmissions for a TB (e.g., one TB) associated with a SLRB/LCH (e.g., one SLRB/LCH) being smaller than a threshold. In examples, for a HARQ disabled SLRB/LCH, the WTRU may determine to perform QoS splitting procedure (e.g., to increase delay budget associated with one or more hops) if the average number of transmissions for a TB (e.g., one TB) is smaller than a threshold. This may allow the WTRU to increase the number of (re)transmissions for a TB (e.g., one TB).

A WTRU (e.g., U2U relay) may trigger a QoS splitting procedure (e.g., calculating the QoS splitting value and/or indicating the QoS splitting value to other nodes) based on the average number of transmissions for a TB (e.g., one TB associated with one SLRB/LCH) being larger than a threshold.

A WTRU (e.g., U2U relay) may trigger a QoS splitting procedure (e.g., calculating the QoS splitting value and/or indicating the QoS splitting value to nodes) based on the average delay associated with the SLRB/LCH being greater/smaller than a threshold.

A WTRU (e.g., U2U relay) may trigger a QoS splitting procedure (e.g., calculating the QoS splitting value and/or indicating the QoS splitting value to other nodes) based on the load of the WTRU becoming greater/smaller than a threshold. In examples, the U2U relay may trigger a QoS splitting procedure (e.g., to increase the delay budget associated with the second hop such as a U2U relay-destination hop) and/or decrease the delay budget associated with the first hop such as a source-U2U relay hop) if the load of the WTRU becomes larger than a threshold. In examples, the U2U relay may trigger a QoS splitting procedure (e.g., to decrease the delay budget associated with the second hop such as the U2U relay-destination hop) and/or increase the delay budget associated with the first hop such as the source-U2U relay hop)) if the load of the WTRU becomes smaller than a threshold.

The WTRU may determine whether to enable/disable HARQ feedback for a TB/SLRB/LCH (e.g., one SLRB/LCH) in a hop (e.g., one hop). In examples, the WTRU may determine whether to enable/disable HARQ feedback for a TB/SLRB/LCH (e.g., one TB/SLRB/LCH) in a hop (e.g., one hop) based on one or more of the following. The WTRU may determine whether to enable/disable HARQ feedback based on whether the associated SLRB/LCH in another hop is HARQ enabled or disabled. In examples, if the associated SLRB/LCH is HARQ enabled, the WTRU may enable HARQ in a hop of the WTRU. If the associated SLRB/LCH is HARQ disabled, the WTRU may enable/disable HARQ in a hop of the WTRU. The WTRU may determine whether to enable/disable HARQ based on another parameter (e.g., CBR). Whether to enable/disable HARQ feedback may be based on a CBR associated with the resource pool. In examples, the WTRU may enable HARQ if the CBR is smaller than a threshold; otherwise, the WTRU may disable HARQ. The congestion level of the resource pool may be reduced by reducing the number of blind retransmission. In examples, the WTRU may enable HARQ if the CBR is larger than a threshold; otherwise, the WTRU may disable HARQ. The reliability of the transmission may be increased by enabling HARQ feedback when there is congestion.

In examples, the WTRU may determine whether the associated SLRB/LCH in another hop is HARQ enabled/disabled. If the associated SLRB/LCH in the other hop is HARQ enabled, the WTRU may enable HARQ for the SLRB/LCH. If the associated SLRB/LCH is HARQ disabled, the WTRU may determine whether to enable/disable HARQ based on the CBR of the resource pool. The WTRU may enable HARQ if the CBR of the resource pool is greater than a threshold; otherwise, the WTRU may disable HARQ.

Network assisted QoS splitting may be provided. The WTRU may determine which WTRU configures the QoS splitting. A WTRU (e.g., source WTRU or U2U relay) may determine whether QoS splitting is performed and/or the QoS splitting value is transmitted to another WTRU. The decision may be determined based on one or more of the following. The decision may be determined based on a (pre-) configured precedence. In examples, for a U2U relay scenario, the U2U may perform QoS splitting. In examples, for a U2U relay scenario, the source WTRU may perform QoS splitting. The decision may be determined based on whether the WTRU is connecting to a gNB (e.g., whether the WTRU is in RRC connected mode) and/or whether the WTRU is under the network coverage of a gNB. In examples, if the WTRU is in the RRC connected mode, the WTRU may be prioritized to perform the QoS splitting procedure. In examples, if the WTRU is in the RRC connected mode, the WTRU may receive a QoS splitting value from the gNB and the WTRU may indicate such QoS splitting value to another WTRU. In examples, if the WTRU is in the RRC connected mode, another WTRU be prioritized to perform QoS splitting procedure. The WTRU may receive the QoS splitting associated with the hop of the WTRU. The WTRU may indicate the QoS splitting associated with a hop of the WTRU to the gNB. Such a decision may be determined based on the resource allocation mode associated with a hop (e.g., each hop). In examples, if one of the WTRUs is in mode 1 and the other WTRU is in mode 2, the WTRU may determine which WTRU performs the QoS splitting procedure based on a (pre-)configured precedence. In examples, the WTRU in mode 1 may perform the QoS splitting procedure. In examples, the WTRU in mode 2 may perform the QoS splitting procedure.

The WTRU may be (pre-)configured the range of QoS splitting. In examples, the WTRU may be (pre-)configured a range of QoS splitting (e.g., PDB splitting). If the WTRU is out of coverage, the QoS splitting configuration may be preconfigured. In examples, if the WTRU is in coverage, the QoS splitting configuration may be conveyed to the WTRU via System Information Block (SIB) and/or RRC message. The configured QoS splitting value may be based on one or more of the following: CBR measured by the source and/or the U2U relay; SL-RSRP measured by the U2U relay and the destination WTRU; and/or the load of the WTRU.

The WTRU may forward the QoS splitting configuration to another WTRU. A WTRU may receive the QoS splitting configuration from the network (e.g., via an SIB). The WTRU may forward the configuration to another WTRU, which may help another WTRU perform a QoS splitting procedure. The WTRU may determine whether to forward the QoS splitting configuration to the other WTRU based on one or more of the following. The WTRU may determine whether to forward the QoS splitting configuration to the other WTRU based on the coverage status of another WTRU. In examples, the WTRU may receive an indication from another WTRU regarding the network coverage status. The WTRU may determine whether to forward the QoS splitting configuration receiving from its serving gNB based on whether the other WTRU is in coverage or out of coverage. The WTRU may forward the QoS splitting configuration if another WTRU is out of coverage. Otherwise, if the other WTRU is in coverage, the WTRU may not forward the QoS splitting configuration. The WTRU may determine whether to forward the QoS splitting configuration to the other WTRU based on the RRC status of the other WTRU. In examples, the WTRU may receive an indication from another WTRU regarding the RRC state. The WTRU may determine whether to forward the QoS splitting configuration receiving from its serving gNB (e.g., via RRC) based on whether another WTRU is in RRC connected or not. The WTRU may forward the QoS splitting configuration if another WTRU is in RRC idle/inactive. If another WTRU is RRC connected, the WTRU may not forward the QoS splitting configuration. The WTRU may determine whether to forward the QoS splitting configuration to another WTRU based on the reception of the request from another WTRU. In examples, the WTRU may trigger sending the QoS splitting configuration based on a request from the other WTRU.

The WTRU may request another WTRU to forward the QoS splitting configuration. In examples, the WTRU may receive an indication from another WTRU regarding the other WTRU's network coverage and/or RRC status. The WTRU may determine to request the other WTRU to forward the QoS splitting configuration, in which the WTRU may assume that the other WTRU received the QoS splitting configuration from the gNB (e.g., via RRC/SIB). The WTRU may request another WTRU to forward the QoS splitting configuration if it is out of network coverage.

The WTRU may determine which QoS splitting configuration to use. In examples, a WTRU (e.g., U2U relay) may receive one or more of the following QoS splitting configurations: a preconfigured QoS splitting configuration; a QoS splitting configuration received from SIB/RRC from the serving gNB of the WTRU; or a QoS splitting configuration received from another WTRU (e.g., source WTRU). The WTRU may determine the priority associated with a QoS splitting configuration (e.g., each QoS splitting configuration). The WTRU may determine which QoS splitting configuration to use based on the (pre-) configured precedence associated with a QoS splitting configuration. In examples, the WTRU may put the QoS splitting configuration received via SIB/RRC of its serving gNB as the highest priority. The WTRU may put the QoS splitting configuration received from another WTRU (e.g., source WTRU) as the second highest priority. The WTRU may put the preconfigured QoS splitting configuration as the third highest priority. The WTRU may determine which QoS splitting to use based on the highest priority available QoS splitting configuration.

The WTRU may receive the configuration of a delay budget in its hop. In examples, the WTRU under network coverage may receive QoS splitting value (e.g., the delay budget in its hop for each SLRB/LCH) by the gNB. The WTRU may indicate the delay budget in its hop to the other WTRU to support the other in determining the delay budget for the next hop. In examples, the source WTRU under the network coverage may receive the delay budget value associated with the first hop (e.g., the hop between source WTRU and U2U relay). In examples, the source WTRU may indicate the received delay budget value associated with the first hop to the U2U relay. The source WTRU may indicate the E2E PDB to the U2U relay to help the U2U relay calculate the delay budget in the second hop (e.g., U2U relay-destination hop). In examples, the source WTRU, may determine the delay budget associated with the first hop and may calculate the delay budget associated with the second hop. The Source WTRU may indicate the delay budget associated with the second hop to the U2U relay.

The WTRU may indicate the delay budget associated with the hop of the WTRU to the gNB. In examples, the WTRU may receive the QoS splitting value (e.g., the delay budget value of the hop) associated with another hop. The WTRU may determine the QoS splitting value associated with the hop of the WTRU based on the E2E QoS and the indicated QoS splitting value from another hop. The WTRU may indicate the QoS splitting value associated with the hop of the WTRU to the gNB. Such indication may be triggered from receiving the QoS splitting value from the other node. This may support the gNB in sidelink scheduling.

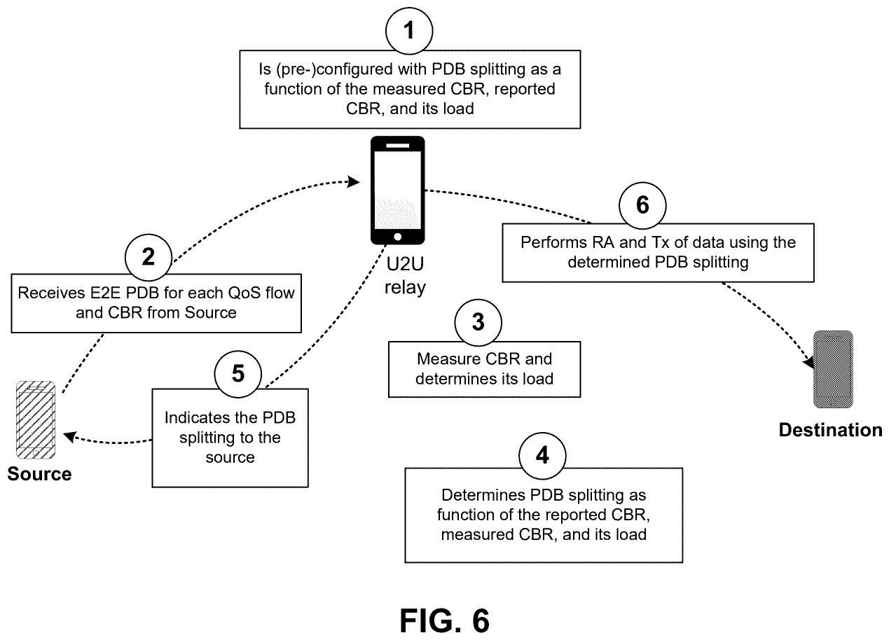

FIG. 6 illustrates an example of PDB splitting. A WTRU (e.g., U2U relay WTRU) may determine/implement PDB splitting between two hops (e.g., see FIG. 6). PDB splitting may be performed when WTRUs (e.g., both source WTRUs and U2U relay) are out of coverage. In examples, a WTRU (e.g., a U2U relay, a relay WTRU, a first WTRU, etc., where relay WTRU may be used as an example) may determine a PDB splitting ratio between two hops based on a reported CBR from a source WTRU, its measured CBR (e.g., CBR of the WTRU), and a load of the WTRU. The relay WTRU (e.g., U2U Relay) may perform one or more of the following for PDB splitting between hops, e.g., source-relay and relay-destination hop (e.g., as illustrated in FIG. 6). The relay WTRU may be (pre-)configured with information/parameters (e.g., an indication of how to calculate different PDB splitting ratio values based on different values of a CBR measured by the relay WTRU, a reported CBR reported by the source WTRU, and/or a load of the relay WTRU (e.g., the relay WTRU may be configured with a table, and a row of the table may be selected, for example based on one or more of the relay WTRU CBR, source WTRU CBR, or load information). For example, the relay WTRU may be configured to determine a PDB splitting ratio (e.g., how to split a PDB between two hops) as a function of the CBR measured by the relay WTRU, the reported CBR reported by the source WTRU, and/or the load of the relay WTRU (e.g., see FIG. 6). The relay WTRU may receive the E2E PDB and CBR measurement (e.g., for an SLRB/LCH) from the source WTRU (e.g., the second WTRU) (e.g., see FIG. 6). The relay WTRU may measure a CBR (e.g., see FIG. 6). The CBR measured by the relay WTRU may be of the resource pool. The relay WTRU may determines the load of the relay WTRU (e.g., channel occupancy ratio (CR)) (e.g., see FIG. 6). The relay WTRU may determine the PDB splitting ratio based on the CBR measured by the relay WTRU, the CBR reported by the source WTRU, the and/or the load of the relay WTRU (e.g., see FIG. 6). The relay WTRU may determine PDB splitting ranges based on the CBR measured by the relay WTRU and the CBR reported by the source WTRU, and the relay WTRU may (e.g., may then) determine the PDB split value based on the load of the relay WTRU. The PDB split value (e.g., a first hop PDB value and/or a second hop PDB value) may be based on the E2E PDB and the PDB split information. The relay WTRU may indicate the PDB splitting ratio value or a source hop PDB value to the source WTRU (e.g., see FIG. 6). The relay WTRU may perform resource selection and transmission of a transport block (TB) from the source WTRU based on the determined PDB splitting (e.g., determined PDB splitting ratio/value), for example for a QoS flow associated with the TB.

PDB splitting may occur when the source is in mode 1 and the U2U relay is in mode 2. In examples, a WTRU (e.g., source WTRU) may calculate/determine the PDB of the first hop (e.g., source-U2U relay hop) and trigger reporting of the PDB to the gNB based on a reception of the PDB in the second hop from the U2U relay. The WTRU (e.g., source WTRU) may perform one or more of the following procedure for QoS splitting between the source-relay and relay-destination hop. The source WTRU may receive the PDB configuration (e.g., from U2U relay) may which indicate the PDB for an SLRB/LCH of the second hop (e.g., U2U relay-Destination). The source WTRU may determine the PDB associated with the first hop based on the indicated PDB in the second hop and the E2E PDB of the SLRB/LCH. The source WTRU may trigger/report the PDB in the first hop to the gNB.

HARQ may be enabled/disabled. In examples, a WTRU (e.g., source WTRU) may determine whether to enable/disable HARQ feedback for a TB based on the HARQ enabling/disabling of the associated SLRB/LCH in the second hop indicated from the U2U relay and CBR of the resource pool. The WTRU (e.g., U2U Relay) may perform one or more of the following to determine whether to enable/disable HARQ for a TB or SLRB/LCH (e.g., one TB or SLRB/LCH). The relay WTRU may be (pre-)configured with a CBR threshold to enable HARQ feedback for a HARQ feedback SLRB/LCH. The relay WTRU may receive data from the first hop indicating whether HARQ is enabled/disabled. The relay WTRU may determine whether to enable/disable HARQ for a TB (e.g., one TB) based on whether HARQ is enabled/disabled in the first hop and the CBR of the resource pool. In examples, if HARQ is enabled for the first hop, the relay WTRU may determine to enable HARQ for the second hop. If HARQ is disabled for the first hop, the relay WTRU may determine to enable HARQ for the second hop of CBR is greater than a threshold; otherwise, the relay WTRU may disable HARQ feedback.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. In examples, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A first wireless transmit/receive unit (WTRU) comprising:
a processor configured to:
receive, from a network node, configuration information indicating a Sounding Reference Signal for positioning (SRSp) configuration associated with a second WTRU, a reference Timing Advance (TA) value associated with the first WTRU, a first threshold value, and a second threshold value;
receive, from the second WTRU, a first RSRP measurement;
determine a first TA value associated with the second WTRU, wherein the determination of the first TA value is based on the first RSRP measurement, the reference TA value, and a measurement associated with the network node; and
transmit, to the second WTRU, the SRSp configuration and the first TA value for the second WTRU.

18. The first WTRU of claim 17, wherein the processor is further configured to:
receive, from the second WTRU, a second RSRP measurement; and
send an indication to the second WTRU based on the first RSRP measurement and the second RSRP measurement.

19. The first WTRU of claim 18, wherein, if a difference between the first RSRP measurement and the second RSRP measurement is between the first threshold value and the second threshold value, the processor is further configured to:
determine a second TA value for the second WTRU to use in association with SRSp transmission, wherein the determination of the second TA value is based on at least the first RSRP measurement, the second RSRP measurement, and the first TA value; and
transmit, to the second WTRU, the indication, wherein the indication indicates the second TA value.

20. The first WTRU of claim 18, wherein if a difference between the first RSRP measurement and the second RSRP measurement is above the second threshold value, the processor is further configured to:
transmit, to second WTRU, the indication, wherein the indication indicates to release the SRSp configuration.

21. The first WTRU of claim 18, wherein the first RSRP measurement is associated with a Transmission Reference Point (TRP), and wherein the second RSRP measurement is associated with the TRP.

22. The first WTRU of claim 17, wherein the first TA value indicates a timing advance associated with SRSp transmission by the second WTRU.

23. The first WTRU of claim 17, wherein the first WTRU comprises a relay WTRU, and wherein the second WTRU comprises a target WTRU.

24. A method for a first wireless transmit/receive unit (WTRU) comprising:
receiving, from a network node, configuration information indicating a Sounding Reference Signal for positioning (SRSp) configuration associated with a second WTRU, a reference Timing Advance (TA) value associated with the first WTRU, a first threshold value, and a second threshold value;
receiving, from the second WTRU, a first RSRP measurement;
determining a first TA value associated with the second WTRU, wherein the determination of the first TA value is based on the first RSRP measurement, the reference TA value, and a measurement associated with the network node; and
transmitting, to the second WTRU, the SRSp configuration and the first TA value for the second WTRU.

25. The method of claim 24, wherein the method further comprises:
receiving, from the second WTRU, a second RSRP measurement; and
sending an indication to the second WTRU based on the first RSRP measurement and the second RSRP measurement.

26. The method of claim 25, wherein, if a difference between the first RSRP measurement and the second RSRP measurement is between the first threshold value and the second threshold value, method further comprises:
determining a second TA value for the second WTRU to use in association with SRSp transmission, wherein the determination of the second TA value is based on at least the first RSRP measurement, the second RSRP measurement, and the first TA value; and
transmitting, to the second WTRU, the indication, wherein the indication indicates the second TA value.

27. The method of claim 25, wherein if a difference between the first RSRP measurement and the second RSRP measurement is above the second threshold value, the method further comprises:
transmitting, to second WTRU, the indication, wherein the indication indicates to release the SRSp configuration.

28. The method of claim 25, wherein the first RSRP measurement is associated with a Transmission Reference Point (TRP), and wherein the second RSRP measurement is associated with the TRP.

29. The method of claim 24, wherein the first TA value indicates a timing advance associated with SRSp transmission by the second WTRU.

30. The method of claim 24, wherein the first WTRU comprises a relay WTRU, and wherein the second WTRU comprises a target WTRU.
